(19) United States
(12) Patent Application Publication
(10) Pub. No.: US 2012/0123971 A1
(43) Pub. Date: May 17, 2012

(54) Print and/or electronic advertising on medical waiting room paging systems either on a UHF pager, iPod MP3 or similar device

(76) Inventor: Daren Allen Holaday, Franklin, TN (US)

(21) Appl. No.: 12/909,053

(22) Filed: Nov. 12, 2010

(51) Int. Cl. G06Q 90/00

(52) U.S. Cl. 705/500

(57) ABSTRACT

The technical disclosure of my invention consists of print or electronic advertising on paging devices which are placed in medical provider offices. The patent is not on the paging device, only on the invention of advertising on these devices.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

In December 2006 while waiting on the pediatrician to call my daughter back for her routine vaccinations the sick patients' around us caused me concern. The idea occurred to me that restaraunts have long used paging systems to notify their customers when ready so why not the medical field?

Financial obstacles prevent medical providers from purchasing pager systems and a gap exists in the medical industry's ability to target advertising with precision based on patient type which makes pager advertising a perfect vehicle for this use and provides benefit to both patients and providers.

Typical direct to consumer ad run in a printed magazine with the hope that a patient might pick up the magazine and turn to the ad or insert a medical company purchases.

### BRIEF SUMMARY OF THE INVENTION

When a patient arrives at their doctor's office, they are handed a paging device. The patient then has the flexibility to leave the waiting room area. When the physician is ready for the patient, the receptionist simply pushes a button from an administrative keypad and the patient's pager buzzes in their hand. Inevitably the patient looks at the pager at this point. On each pager an ad roughly the size of a business card or an iPod with electronic advertising is placed. The medical advertiser can effectively target an ad campaign with precision in the waiting room environment. This patent is submitted only for the direct to consumer advertising on these paging devices, not the pager device itself. The pager systems also alleviates several common problems in a medical waiting room environment, namely Privacy (negates the need to verbalize the patient's name), reduced exposure to infection or other patients who are ill and an increase in patient satisfaction. By paying for the pagers through advertising it creates a win for patients, medical providers and advertisers.

### BRIEF DESCRIPTION OF THE SEVERAL VIEWS OF THE DRAWING

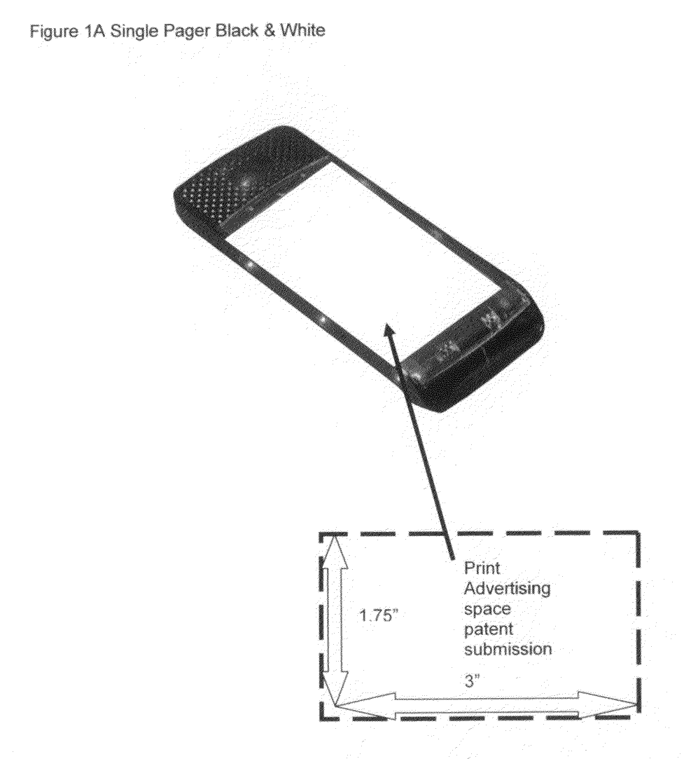

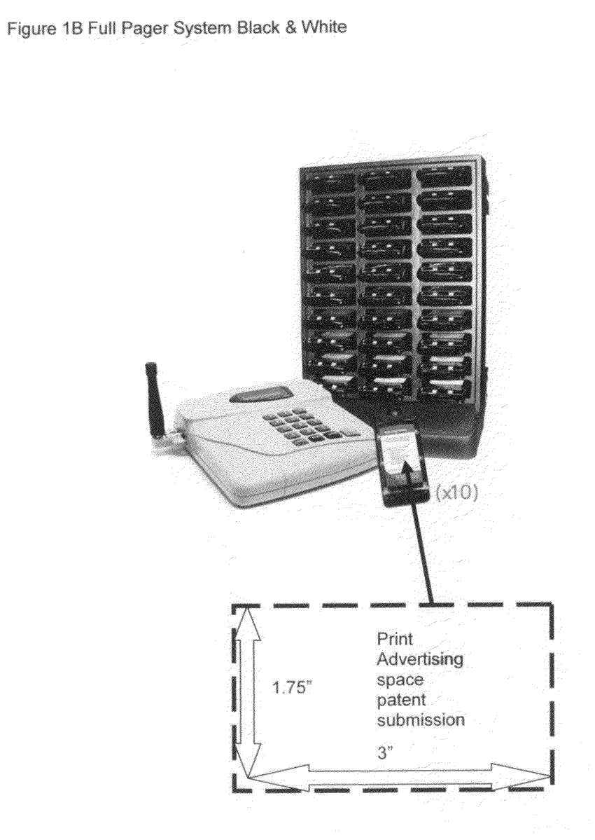

The advertising format can take place in two separate manners: (FIG. 1A & B) An ad measuring approximately 1¾ inches×3 inches is printed in black and white or color on a cell phone size UHF pager.

### Or

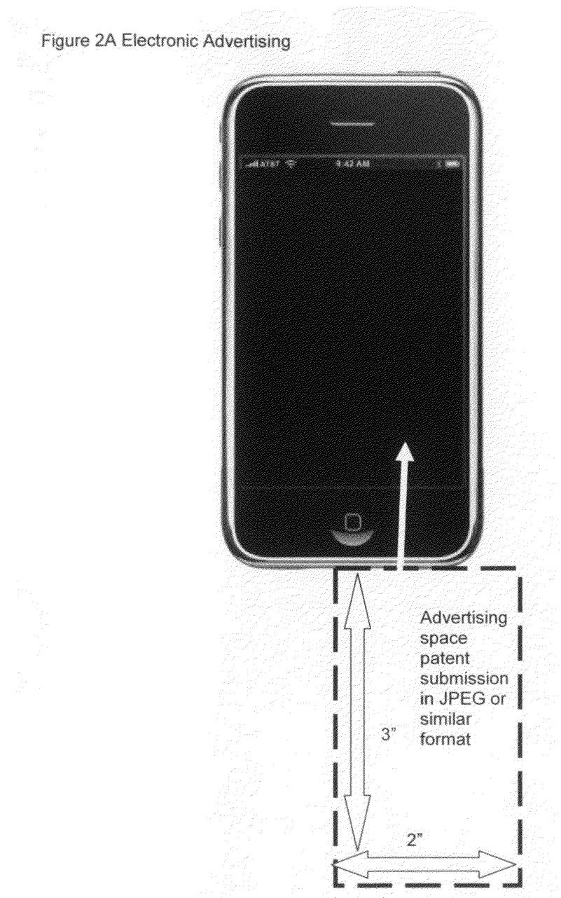

(FIG. 2A) A computerized paging device (iPod or similar device) with advertising in the following one of the following electronic picture formats: JPG; JPEG; TIFF; TIFF; JPEG 2000; RAW; PDF; PNS; PNG; GIF; BMP; PPM; PGM; PBM; PNM; WEBP; CGM; JPS; MPO rotates ads at random intervals.

### DETAILED DESCRIPTION OF THE INVENTION

The invention for which this patent is submitted consists of “pager device advertising” to be used in medical waiting rooms which can take place in two separate manners; either an space measuring approximately 1¾ inches×3 inches (FIG. 1A & B) for printed advertising in black and white or color on a cell phone size UHF pager or a computerized paging device (iPod or similar device) with advertising in the following one of the following electronic picture formats: JPG; JPEG; TIFF; TIFF; JPEG 2000; RAW; PDF; PNS; PNG; GIF; BMP; PPM; PGM; PBM; PNM; WEBP; CGM; JPS; MPO (FIG. 2A).

While multiple companies produce paging systems to my knowledge no corporate entity or individual in the USA currently places advertising space on any paging systems or has invented a similar use for these pagers. This advertising space is targeted for use by medical companies who would like to increase knowledge of their products via direct to consumer advertising to medical patients.

1. This patent submission is for the invention of print or electronic advertising on paging devices which are placed in medical provider offices.
